(19) United States
(12) Patent Application Publication
(10) Pub. No.: US 2015/0233178 A1
(43) Pub. Date: Aug. 20, 2015

(54) CORD-LESS SCROLLING DEVICE AND METHOD FOR SCROLLING OPERATION WIRE OF WINDOW CURTAIN

(71) Applicant: CHING FENG HOME FASHIONS CO., LTD., Fuxing Shiang (TW)

(72) Inventors: SHENG-YING HSU, Fuxing Shiang (TW); WU-CHUNG NIEN, Fuxing Shiang (TW)

(21) Appl. No.: 14/184,646

(22) Filed: Feb. 19, 2014

(51) Int. Cl. E06B 9/322; E06B 9/38; B65H 75/48; E06B 9/60

(52) U.S. Cl. CPC E06B 9/322; E06B 9/60; E06B 9/38; B65H 75/486; E06B 2009/3222

(57) ABSTRACT

The operation wire scrolling device includes a resilient member with has a first end and a second end. The scrolling force of the first end is larger than that of the second end. The second end of the resilient member is securely wrapped to the central pin of the scrolling member, and the first end of the resilient member is securely wrapped to the side pin of the scrolling member. When the operation wire is pulled, the second end of the resilient member does not pull the first end of the resilient member so that the position of the curtain is set.

### FIELD OF THE INVENTION

The present invention relates to a cord-less scrolling device and the method for scrolling the operation wire of a window curtain, and more particularly, to a cord-less scrolling device that ensures that the operation wire of the window curtain is not pulled backward.

### BACKGROUND OF THE INVENTION

The conventional scrolling device for operation wires of a window curtain is disclose in FIGS. 9 to 11, and the resilient member 30 includes a first end 31 and a second end 32. The first and second ends 31, 32 have identical resilient force and this means that the first and second ends 31, 32 have the same scrolling force. However, when scrolling the operation wires of the window curtain, because the first and second ends 31, 32 of the resilient member 30 have the same scrolling force, so that the first end 31 or the second end 32 may draw the second end 32 or the first end 31 backward. This means that the curtain may be moved due after being set because the first end 31 or the second end 32 may draw the second end 32 or the first end 31 backward. Besides, the resilient member 30 can reach to its fatigue point within a short period of time.

The present invention intends to provide a cord-less scrolling device and the method for scrolling the operation wire of a window curtain, the resilient member is designed to improve the shortcomings of the conventional resilient member.

### SUMMARY OF THE INVENTION

The present invention relates to an operation wire scrolling device and comprises a resilient member with has a first end and a second end. The scrolling force of the first end is larger than that of the second end. The scrolling member has a central pin and a reel is mounted to the central pin. At least one side pin is located beside the central pin. The second end of the resilient member is securely wrapped to the central pin of the scrolling member and the first end of the resilient member is securely wrapped to the side pin of the scrolling member. When the operation wire is pulled, the second end of the resilient member does not pull the first end of the resilient member so that the position of the curtain is set.

The method for scrolling the operation wire of a window curtain is to make the resilient member have a first end and a second end. The scrolling force of the first end is larger than that of the second end. By the difference of the scrolling force, when the height of the curtain is set, the second end cannot pull the first end backward, so that the operation wire does not pulled back.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the scrolling device of the present invention;

FIG. 2 is a perspective view to show the window curtain with the scrolling device of the present invention;

FIG. 3 shows that the resilient member of the present invention is in scrolled status;

FIG. 4 shows that the resilient member of the present invention is expanded in axial direction;

FIG. 5 is a diagram showing the relation between the scrolling force and the first end and the second end of the resilient member;

FIG. 6 shows that multiple first and second holes are defined through the resilient member;

FIG. 7 shows that an elongate slot is defined through the resilient member;

FIG. 8 shows that the resilient member has tapered lateral sides;

FIG. 9 shows that the conventional resilient member is expanded in axial direction;

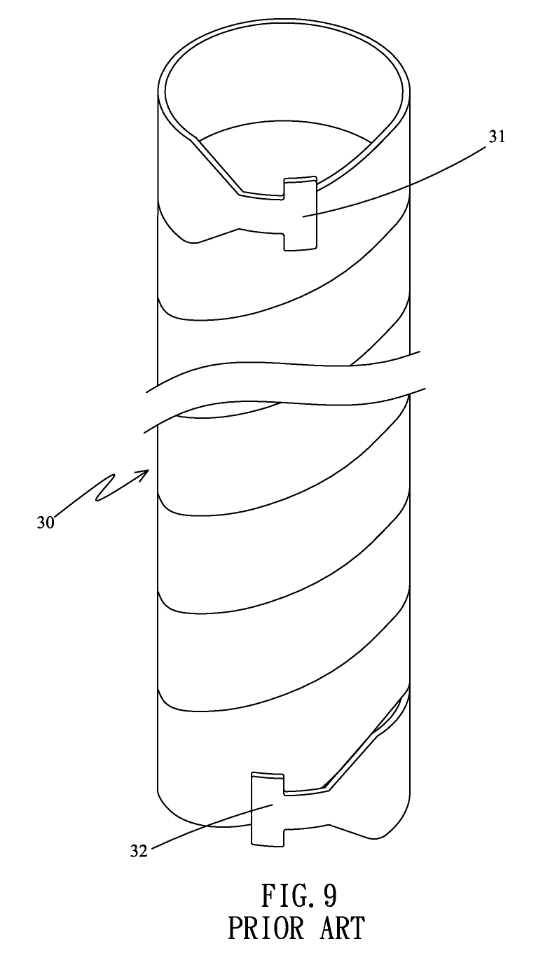

FIG. 10 shows the conventional resilient member is expanded, and

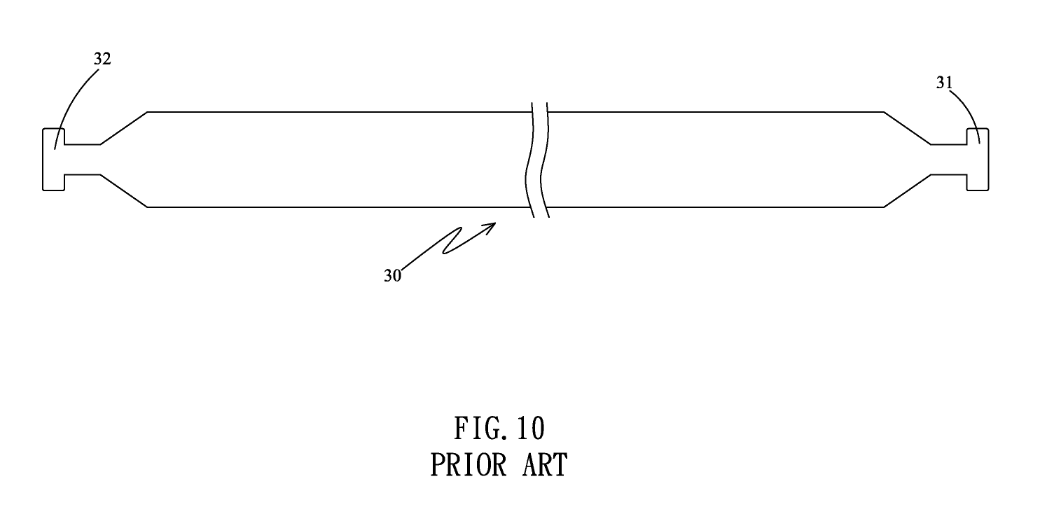

FIG. 11 is a diagram showing the relation between the scrolling force and the first end and the second end of the conventional resilient member.

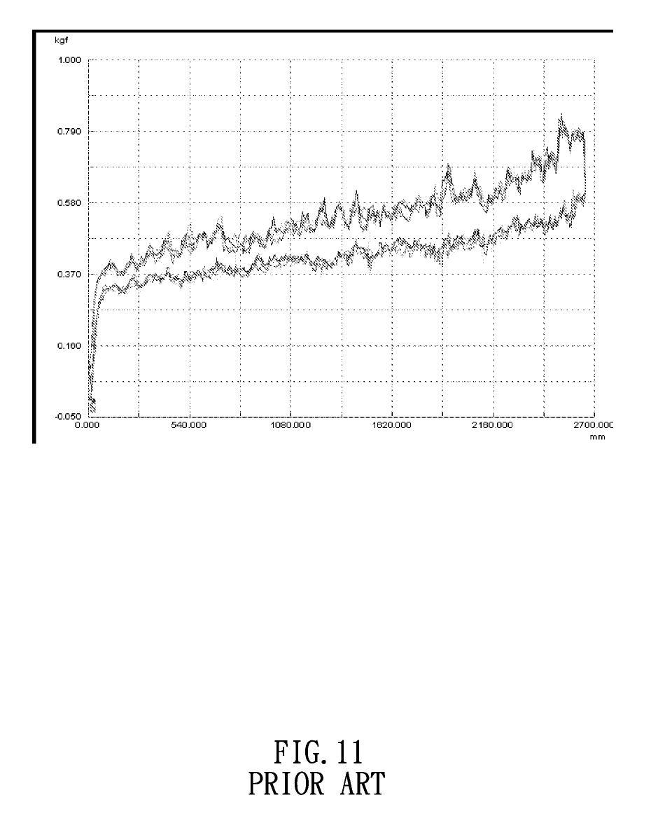

### DETAILED DESCRIPTION OF THE PREFERRED EMBODIMENT

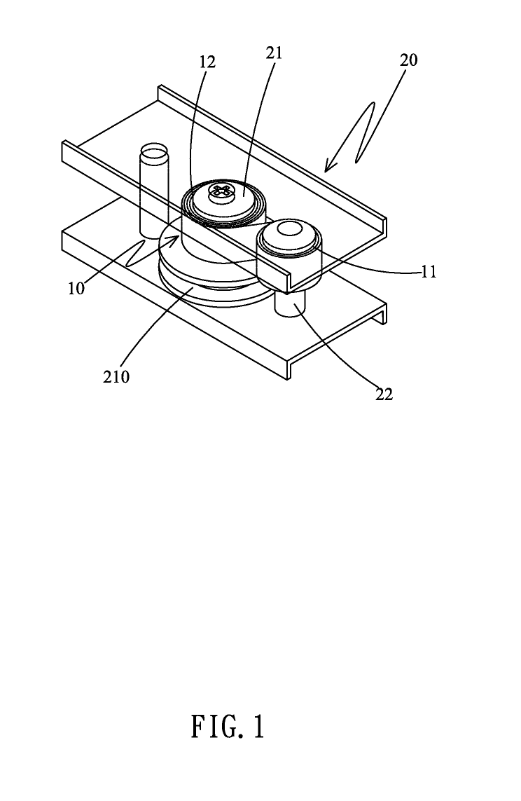

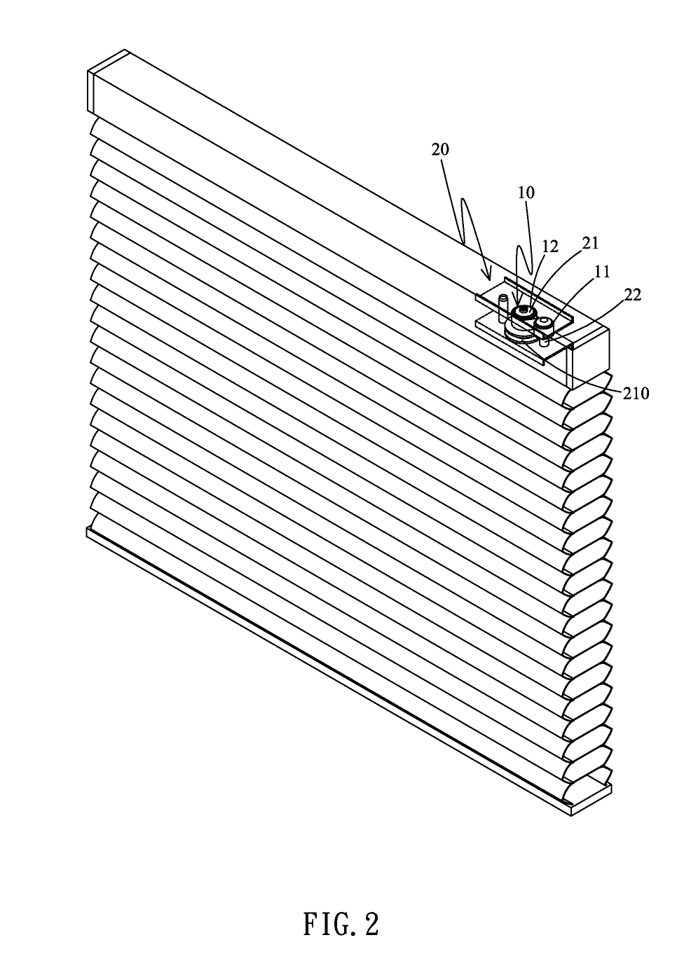

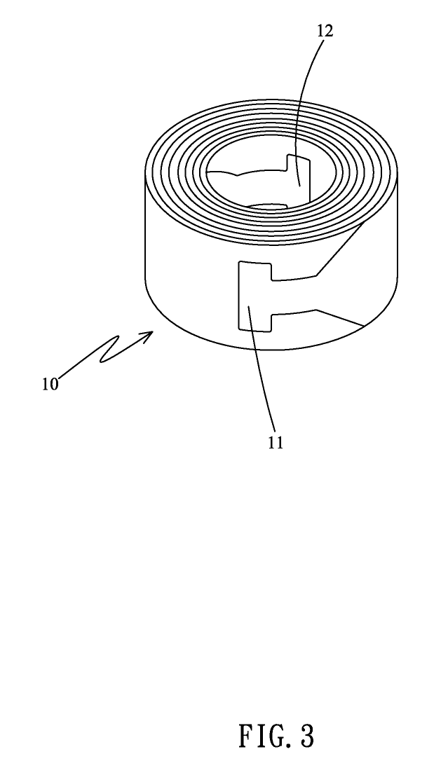

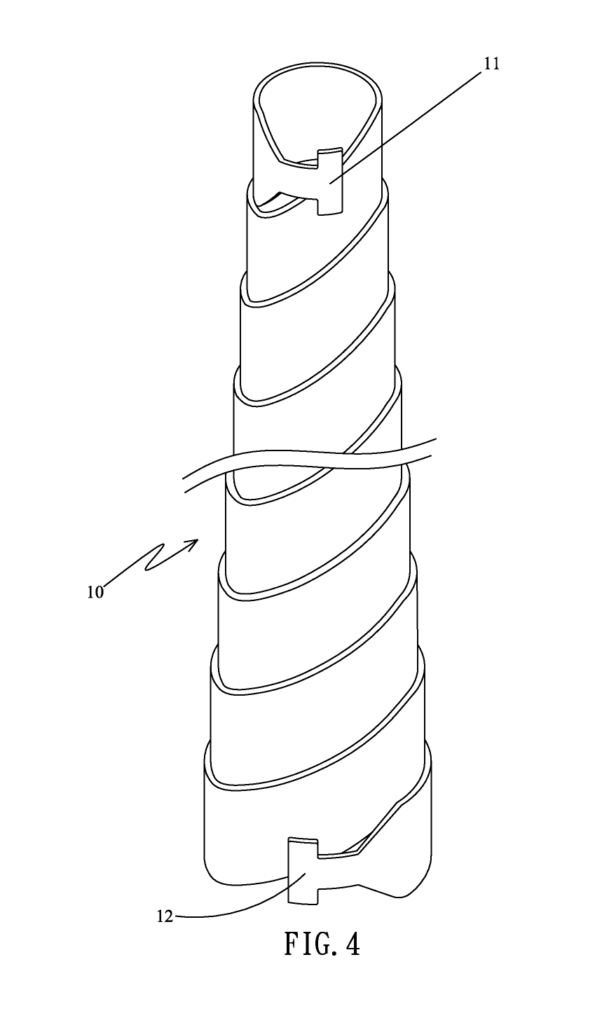

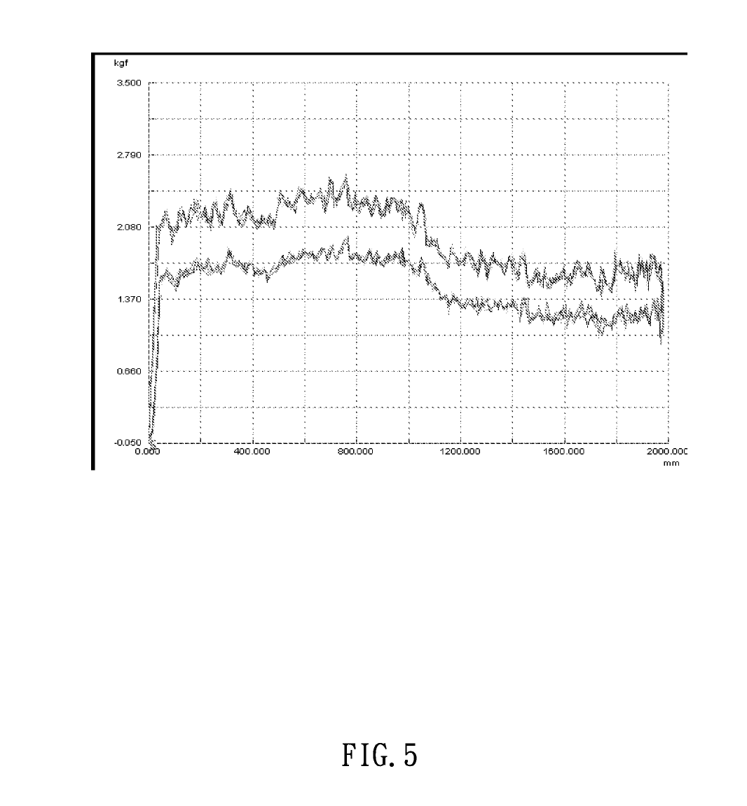

Referring to FIGS. 1 to 4, the method for scrolling the operation wire of a window curtain is to make a resilient member 10 having a first end 11 and a second end 12. The scrolling force of the first end 11 is larger than that of the second end 12 as illustrated in FIG. 5. The second end 12 of the resilient member 10 is securely wrapped to the central pin 21 of the scrolling member 20, and the first end 11 of the resilient member 10 is securely wrapped to a side pin 22 of the scrolling member 20. The scrolling member 20 has a reel 210 connected to the central pin 21 and the operation wire is wrapped to the reel 210 mounted to the central pin 21. When pulling the operation wire to set the height of the curtain (not shown), because the scrolling force of the first end 11 is larger than that of the second end 12, the second end 12 of the resilient member 10 is not pulled out by the first end 11 of the resilient member 10, so that the height of the curtain is not changed.

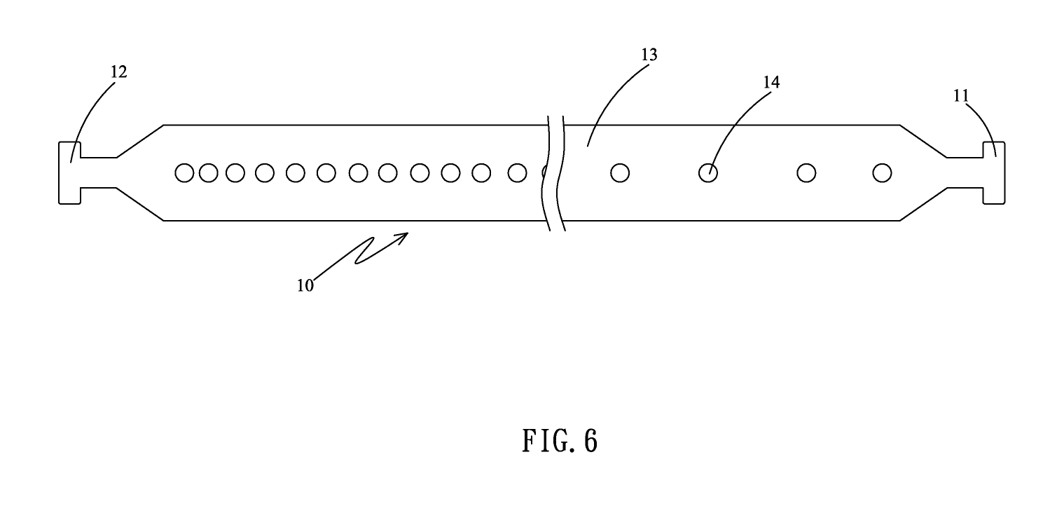

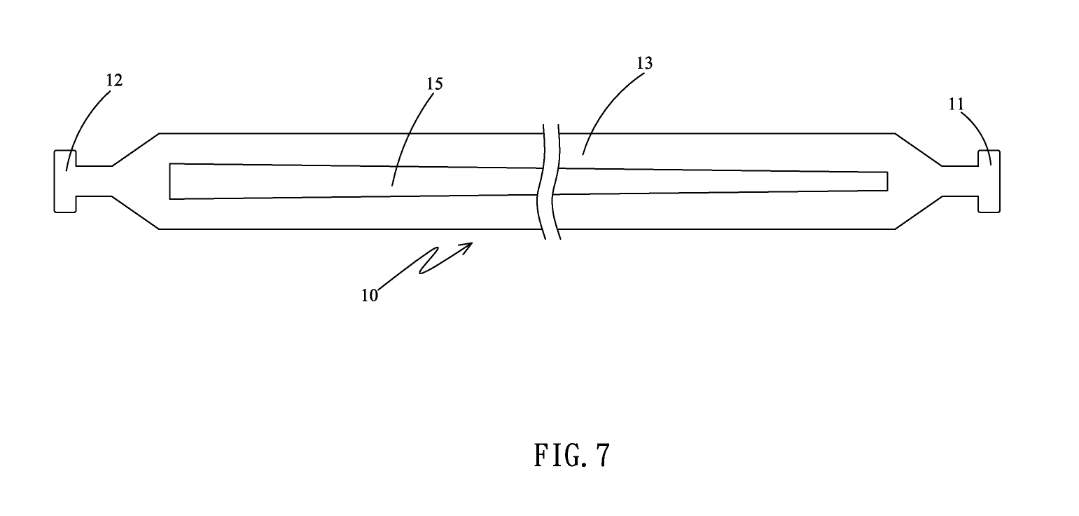

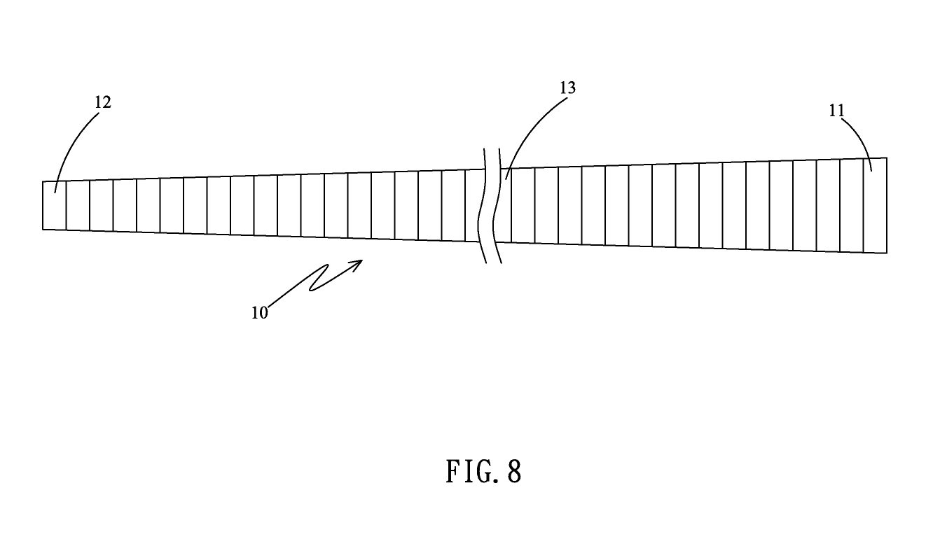

As shown in FIGS. 6 to 8, the resilient member 10 has a mediate portion 13 located between the first and second ends 11, 12. Multiple first holes 14 are defined through the resilient member 10 and located between the first end 11 and the mediate portion 13. Multiple second holes 140 are defined through the resilient member 10 and located between the second end 11 and the mediate portion 13. The gap between any two adjacent first holes 14 is larger than that between any adjacent second holes 140.

Alternatively, an elongate slot 15 is defined through the resilient member 10 and the elongate slot 15 is narrowed from the second end 12 toward the first end 11.

Alternatively, the width of the resilient member 10 is narrowed from the first end 11 toward the second end 12. In other words, the resilient member 10 has tapered lateral sides.

The operation wire scrolling device of the present invention comprises a resilient member 10 having a first end 11 and a second end 12. The scrolling force of the first end 11 is larger than that of the second end 12. The scrolling member 20 has a central pin 21 and a reel 210 is mounted to the central pin 21. At least one side pin 22 is located beside the central pin 21. The second end 12 of the resilient member 10 is securely wrapped to the central pin 21 of the scrolling member 20, and the first end 11 of the resilient member 10 is securely wrapped to the side pin 22 of the scrolling member 20. When pulling the operation wire to set the height of the curtain (not shown), because the scrolling force of the first end 11 is larger than that of the second end 12, the second end 12 of the resilient member 10 is not pulled out by the first end 11 of the resilient member 10, so that the height of the curtain is not changed.

While we have shown and described the embodiment in accordance with the present invention, it should be clear to those skilled in the art that further embodiments may be made without departing from the scope of the present invention.

What is claimed is:

1. A method for scrolling the operation wire of a window curtain, comprising:
making a resilient member having a first end and a second end, a scrolling force of the first end being larger than that of the second end;
the second end of the resilient member being securely wrapped to a central pin of a scrolling member, the first end of the resilient member being securely wrapped to a side pin of the scrolling member, and
wrapping operation wire to a reel mounted to the central pin, when pulling the operation wire, the second end of the resilient member is not pulled out by the first end of the resilient member.

2. An operation wire scrolling device, comprising:
a resilient member having a first end and a second end, a scrolling force of the first end being larger than that of the second end, and
a scrolling member having a central pin and a reel mounted to the central pin, at least one side pin located beside the central pin, the second end of the resilient member being securely wrapped to the central pin of the scrolling member, the first end of the resilient member being securely wrapped to the side pin of the scrolling member.

3. The device as claimed in claim 2, wherein the resilient member has a mediate portion located between the first and second ends, multiple first holes are defined through the resilient member and located between the first end and the mediate portion, multiple second holes are defined through the resilient member and located between the second end and the mediate portion, a gap between any two adjacent first holes is larger than that between any adjacent second holes.

4. The device as claimed in claim 2, wherein an elongate slot is defined through the resilient member and narrowed from the second end toward the first end.

5. The device as claimed in claim 2, wherein a width of the resilient member is narrowed from the first end toward the second end.
